(19) United States
(12) Patent Application Publication
(10) Pub. No.: US 2012/0096675 A1
(43) Pub. Date: Apr. 26, 2012

(54) Hinge

(76) Inventors: Mark S. Tracy, Tomball, TX (US); Earl W. Moore, Cypress, TX (US)

(21) Appl. No.: 13/379,432

(22) PCT Filed: Jul. 28, 2009
(86) PCT No.: PCT/US09/52017

§ 371 Date: Dec. 20, 2011

(51) Int. Cl. E05D 11/00; B23P 11/00

(52) U.S. Cl. 16/223; 29/428

(57) ABSTRACT

To attach a first part of a computing device to a second part of a computing device a clutch 105 can be used. The clutch can include a first side 113 and a second side 114. The clutch can attach to a first part of the computing device. A shaft 110 can extend from the clutch on the first side. A mounting bracket 120 can attach the shaft to the second part of the computing device.

### BACKGROUND

Portable computing devices, for example notebook computers, can include many features of a desktop computer in a portable package. A portable computing device includes a display pivotally attached to the base of the portable computing device. A liquid crystal display (LCD) generates the colors or patterns that arc viewable to the user by applying electrical current to a liquid crystal to change its ability to transmit light. To view the patterns on the liquid crystal displays an external light source such as a back light can be used. The LCD panel can be mounted between a user and the back light. The light from the back light is transmitted through the LCD to allow the user to view the images created by the LCD. The back light may have a light source such as a cold cathode florescent light (CCFL) that is mounted on the top, bottom, left or right side of the display and provides light to a light guide. The light guide transmits the light from the light source evenly to the back of the LCD panel. A portion of the light source or the light guide may be behind the bezel surrounding the LCD panel. The electrical current for the LCD panel and the back light comes from the base of the computer. The housing for the display may include other peripherals, for example a camera, microphone, and antennas which may be connected to the base of the computer. Cables for the display and the peripherals are routed into the display housing.

### BRIEF DESCRIPTION OF THE DRAWINGS

Some embodiments of the invention are described with respect to the following figures:

FIG. 1 is a device according to an exemplary embodiment of the invention;

FIG. 2 is a device according to an exemplary embodiment of the invention;

FIG. 3 is a device according to an exemplary embodiment of the invention;

FIG. 4 is a system according to an exemplary embodiment of the invention;

FIG. 5 is a system according to an exemplary embodiment of the invention;

FIG. 6 is a system according to an exemplary embodiment of the invention: and

FIG. 7 is a flow diagram according to an exemplary embodiment of the method of the invention.

### DETAILED DESCRIPTION

A portable computing device can include features that may be an external component in a desktop computer. A portable computing device can have a wireless connection that includes antennas to connect to a network or the internet. A portable computing device can have a camera, a microphone and a display. The components may be in a display housing of a portable computing device, such as a note book computer or a portable phone.

A component in the display housing of the portable computing device can use electrical connections to the controllers in the base of the portable computing device. For example the display is connected to the display driver circuits in the base of the computer and the antenna may be connected to the wireless module circuits in the base of the portable computing device. Cables can be used for the electrical connections, for example. The cable or cables for a component pass from the base of the portable computing device to the display housing of the portable computing device. The base of a portable computing device has a top that can include a keyboard and a bottom of the portable computing device may be placed on a desk for example. To allow room for the cables that are connected from the base to the peripherals in the display housing the axis of rotation of the hinge may below the top of the base of the computer, this is known as a drop hinge. Moving the axis of rotation of the hinge below the top of the base of the computer allows the opening in the display housing for the hinge to be larger than the hinge without increasing the height of the portable computer to allow room for the cables to pass through. For example if total height of the computer is 3 centimeters and the opening for the hinge is 0.5 centimeters the opening the axis of rotation is at 1.5 centimeters the opening of the hinge can be increased without increasing the height. The axis of rotation of the display may be near the back of the base of the portable computing device. If a portable computing device uses a drop hinge a portion of the display housing may rotate behind the back of the base of the portable computing device.

Portable computing devices may have accessories that can attach to the portable computing devices. For example, a portable computing device may attach to a docking station or an external secondary battery. If a drop hinge is used for the display the accessories may not connect to the portable computing device if a portion of the display housing is covering the back of the portable computing device. If the axis of rotation of the display is above the top of the base of the portable computing device the back of the base of the computer is not covered when the display is rotated away from the base. The size of the opening for the hinge may affect the height of a portable computing device if the display is rotated toward the base of the portable computing device in a closed position. Increasing the size of the opening in the display housing for the hinge to install a cable of a component through may increase the height of the computer. For example if the height of the portable computing device is 3 centimeters and the opening for the hinge is 0.5 centimeters and the axis of rotation is above the top of the base any increase in the opening may increase the height of the portable computing device above 3 centimeters.

The light guides for some back lights arc larger than others depending on the light source. For example the light guide on a CCFL light source may be smaller than the light guide on a light emitting diode (LED) light source. The display housings with a smaller housing may have a space around the backlight that can be used for routing the cables but the larger backlight may use that space for the cable and the cables would have to be routed in another way so that the size of the display housing does not have to be increased to route the cables.

In one embodiment, a computing device hinge system includes a clutch attached to a first part. The first part may be the base of the computer. A shaft can be attached to a second part of the computer device. The second part of the computing device can be the display enclosure. The shaft can extend from a first side of the clutch opposite a second side of the clutch. A first cable can be routed on the first side of the clutch and a second cable can be routed on the second side of the clutch. Routing the cables on both a first and a second side of the clutch allows more options for routing the cables without increasing the height of the computer. The shaft may be attached to the second part with a mounting bracket. A space between the mounting bracket and the clutch can allow a cable to be routed from the first part to the second part between the mounting bracket and the clutch.

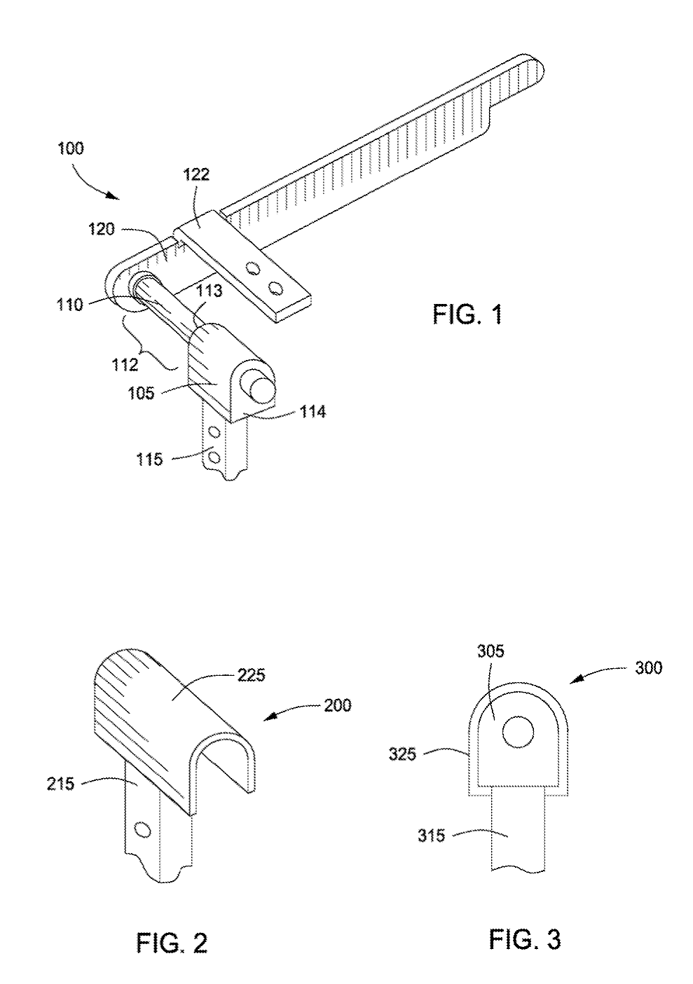

With reference to the figures, FIG. 1 is a device according to an exemplary embodiment of the invention. A hinge device 100 can include a clutch 105. The clutch 105 includes a first side 113 and a second side 114 opposite the first side 113. The clutch can also include a support 115 for attaching the clutch. In one embodiment, the support 115 for the clutch may have openings for accepting a fastener to attach the clutch to a portable computing device. The clutch may be attached to a portable computing device with a fastener, for example a screw, rivet or an adhesive. The support may be attached to the base of the portable computing device, in one embodiment. The support may be formed as one piece with the clutch or may be a separate component that is attached to the clutch.

A shaft 110 extends from the clutch 105 on the first side 113. The shaft 110 can rotate relative to the clutch 105. A mounting bracket 120 can be attached the shaft 110. The mounting bracket 120 may include a tab 122 to attach a second part of a portable computing device to the tab 122. The tab may have an opening to accept a fastener if the tab is attached to a second part of the portable computing device. The tab may be attached to the second part of the portable computing device with a fastener, for example a screw, rivet, or an adhesive. A gap 112 is between the mounting bracket 120 and the clutch 105 to allow a first cable to route along the first side 113 and through the gap 112 between the mounting bracket 120 and the clutch 105. The shaft 110 length can determine the size the gap 112 that can be used to route a first cable on the first side 113. The distance between the clutch and the mounting bracket may be for example between 0.5 centimeters and 1.5 centimeters but may be different distances. A second cable may be routed on the second side of the clutch.

The tab 122 can be positioned on the mounting bracket 120 with a space between the tab 122 and the shaft 110. The tab 122 can be used to attach the mounting bracket 120 to a display enclosure. The space between the shaft 110 and the tab 122 can be used to route a first cable between the shaft 110 and the tab 122.

In one embodiment, the clutch applies constant torque to the shaft. The torque applied to the shaft provides an opposite force to counter the gravitational force acting on the second part that can be attached to the mounting bracket. The torque can allow the shaft to rotate relative to the clutch if a force in addition to the gravitational force is applied to the second part but hold the second part in a position relative to the first part if there is no force in addition to the gravitational force applied to the second part.

FIG. 2 is a device according to an exemplary embodiment of the invention. A cover 225 can cover the hinge 200. The cover can protect the hinge 200 and the cables. The hinge 200 can become damaged if contaminates entered the hinge and prevented the shaft from rotating in relation to the clutch. The cover can also protect a cable on the first or second side of the clutch that may be installed between the first part of the portable computing device and the second part of the portable computing device.

FIG. 3 is a device according to an exemplary embodiment of the invention. In one embodiment, the cover 325 is attached to the clutch 305 with zero space or substantially zero space between the cover 325 and the clutch 305 so that the cover does not increase the height of the portable computing device if the second part such as the display housing of the portable computing device is rotated to a closed position parallel to the first part such as the base of the portable computing device.

In one embodiment the cover 325 is made of the same material as the clutch and formed by metal injection molding (MIM). MIM uses a mold where metal in a liquid form is injected into the mold a cooled to form the clutch. If the cover 325 is formed by MIM the cover may be made as one piece with the clutch 305. In alternative embodiments the cover 325 can be made separate and attached to the clutch 305. If the cover 325 is attached to the clutch 305 the cover may be made of a different material from the clutch 305, for example the cover 325 may be plastic. The cover may also be attached to the base of the portable computing device and extend over the clutch but not be attached to the clutch, in one embodiment.

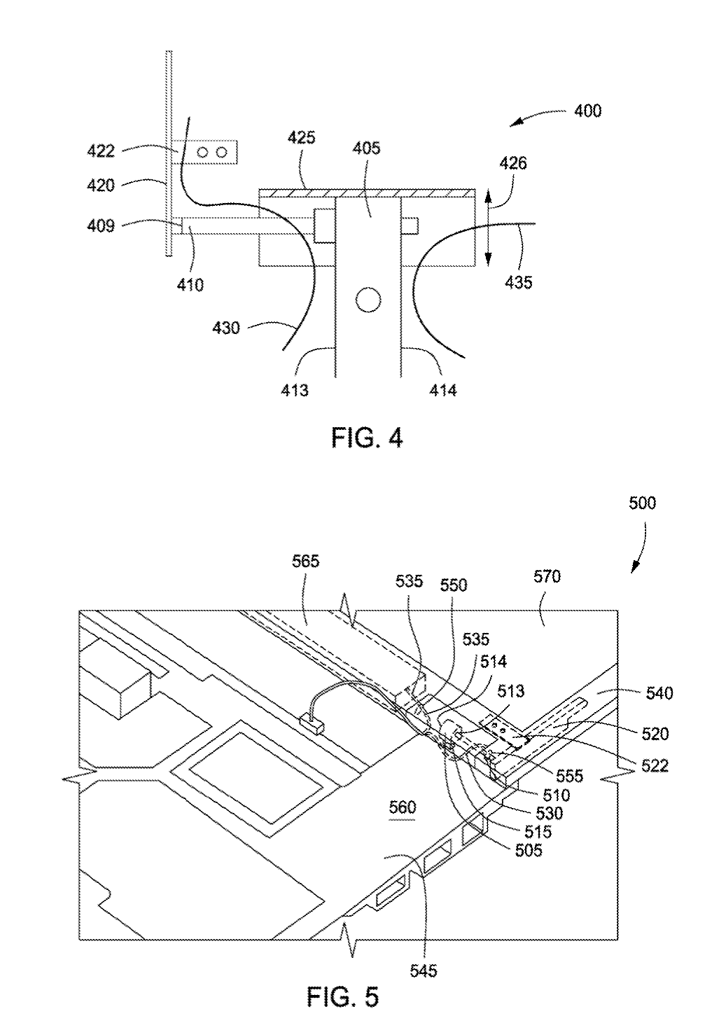

FIG. 4 is a system according to an exemplary embodiment of the invention. In one embodiment, the first cable 430 is routed along the first side 413 of the clutch 405. The first cable 430 can be routed between mounting bracket 420 and the clutch 405 along shaft 410 of the hinge system 400. The length of the shaft 410 can allow the first cable 430 to pass between the mounting bracket 420 and the clutch 405. In one embodiment, the first cable 430 is routed between the shaft 410 and the tab 422 along the mounting bracket 420.

The second cable 435 can be routed along the second side 414 of the clutch 405. The cover 425, shown in a cross sectional view, can extend past both the first side 413 and the second side 414 of the clutch 405. The cover 425 can protect the clutch 405, the shaft 410, the first cable 430 and the second cable 435 from contaminants or from damage. Allowing the first cable 430 to be routed along the shaft 410 of the hinge system 400 can reduce the number of cables that are routed on the second side 414 of the clutch 405. The diameter 409 of the shaft 410 can allow a first cable 410 on the first side 413 of the clutch 405 to be routed along the shaft 410 without increasing the height 426 of the cover 425 of the hinge system 400. For example if the diameter of the shaft may be between 0.1 centimeter and 0.4 centimeters and the height of the cover may be between 0.7 and 1.2 centimeters allowing a cable to be between the shaft and the cover. For example if the first cable 430 and the second cable 435 arc on the second side 414 of the clutch 405 then the space used for the cables on the second side 414 of the clutch 405 may be increased and the height 426 of the cover may be increased to accommodate the increased volume of the cables on the second side 414. The embodiments may be described as including a first cable and a second cable, the first and the second cables may include multiple signal transmission carriers. For example the first cable may include multiple cables or wires to carry the signal from a video card, sound card, and serial bus ports in the first part of the computing device to a display or a peripheral in the second part of the computing device.

FIG. 5 is a system 500 according to an exemplary embodiment of the invention. The first part 545 may be the base of a portable computing device, in one embodiment. The second part 540 may be the display housing of a portable computing device, in one embodiment. The first part and the second part may also be other parts of a portable computing device or may be parts of another electrical system, for example a portable phone.

In one embodiment, a support 515 can be attached to the first part of a portable computing device 545. The support 515 can be attached with for example screws, rivets, or an adhesive. A clutch 405 can be attached the support 515. In one embodiment, the support 515 and the clutch 405 arc one piece. The clutch has a first side 513 and a second side 514 opposite the first side. A shaft 510 can be attached to a mounting bracket 522. The mounting bracket 522 can extend along the side of the second part 540 of the system 500. The mounting bracket 540 may have a tab 522 attached to the mounting bracket. The tab 540 can be attached to the second part 540 of the system 500. In one embodiment, the second part of the portable computing device can be the display housing.

The shaft 510 can extend from a first side 513 of the clutch 505. The clutch may be positioned above top 560 of the first part 545 of the system, in one embodiment, but may also be positioned below the top 560 of the first part 545 of the system. The top 560 of the first part 545 may include a keyboard for example. The clutch 505 can allow the shaft 510 extending from the first side 513 to rotate relative to the clutch. The mounting bracket 520 attached to the shaft 510 rotates with the rotation of the shaft 510.

The shaft 510 of the system 500 can pass through a first opening 555 in the second part 540 of the system 500. The first opening 555 can be larger than the shaft 510. For example the first opening may be between 0.7 centimeters and 1.2 centimeters if the shaft is between 0.1 centimeters and 0.4 centimeters. The first cable 530 can pass through the first opening 555 with the shaft 510 of the system 500 to route the first cable 530 into the second part.

A second opening 550 can be in the second part 540 of the system 500. A second cable 535 can route through the second opening 550 into the second part 540 of the system 500. In one embodiment, the second part 540 may include a display 570. The display may include an extension 565. The extension may be for example a back light, a light guide, or a display driver. The extension 565 may be a component that is not related to the display 570 such as a wireless module. The extension 565 may prevent the second cable 535 from being routed though the second opening 550 because the extension 565 is located where the second cable 535 enters the second part 540. In one embodiment the second cable may 535 may be routed though the second opening 550 but components in the second part 540 such as a microphone, camera, or wireless antennas use cables that connect the components to the first part 545 and the extension 565 may prevent some of the cables from being routed though the second opening 550.

In one embodiment, the support 515 is attached to the first part 545 through an opening in the top 560. The opening in the top may be divided into two openings by the support 515 or the top 560 may have a third opening and a forth opening. A third opening can be on the first side 513 of the support 515 and allow the first cable 530 to enter the first part 545 though the top 560 of the first part 545. A fourth opening can be on the second side 514 of the support 515 and allow the second cable 535 to enter the first part 545 though the top 560 of the first part 545.

In one embodiment, a cover can be attached to the top 560 of the first part 545 and extend over the clutch 505 between the first opening 555 and the second opening 550. If the cover is attached the first, second, third and fourth openings and the cables that pass though the openings can be protected by the cover. The cover can prevent foreign objects from entering the first or the second part of the system though the openings. The cover may prevent damage to the first and the second cables that pass though the openings by preventing abrasions to the protective coating of the cables.

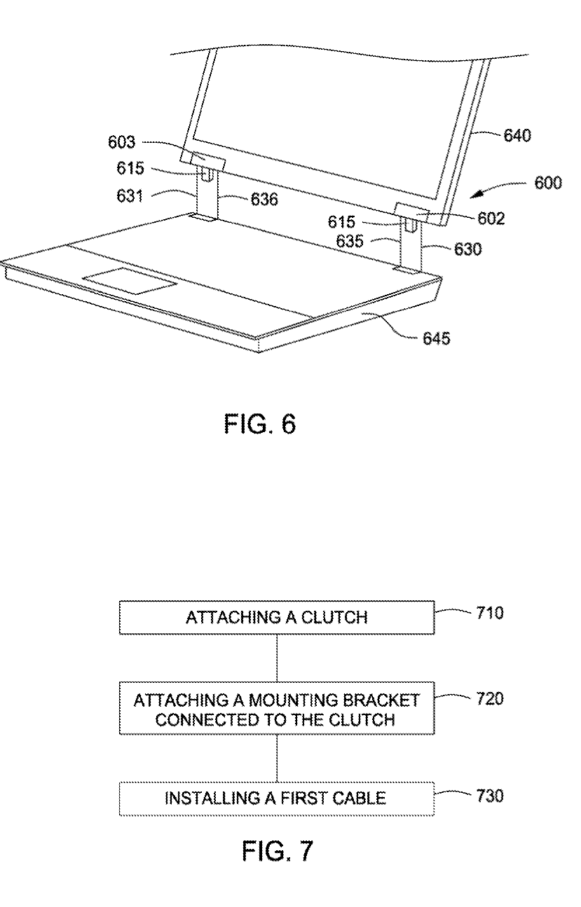

FIG. 6 is a system according to an exemplary embodiment of the invention. The system 600 can include a first hinge device 602 and a second hinge device 603. The first hinge device 602 and the second hinge device 603 can allow the second part 640 to rotate along an axis that is defined by the center of the shaft of the hinge device 602 and the hinge device 603.

The hinge device 602 and the hinge device 603 can have a clutch mounted to allow a first cable and a second cable to be routed along a first and a second side of the clutch. In one embodiment there are four routing options for cables that are routed from the first part 645 to the second part 640. The four routing options arc the first cable 630 on the first side and the second cable 635 on the second side of the hinge device 602. The first cable 631 can be on the first side and the second cable 636 can be on the second side of the hinge device 603.

FIG. 7 is a flow diagram according to an exemplary embodiment of the invention. The method of installing a first cable begins by attaching a clutch including a first side to a first part (at 710) of a portable computing device. In one embodiment, the first part can be the base of a portable computing device but may also be the display housing of the portable computing device.

A mounting bracket can be mounted to the second part (at 720). The clutch and the mounting bracket can be connected by a rotatable shaft. The mounting bracket may be attached to the second part using a tab on the mounting bracket. The second part can be the display housing or the display in the display housing. The shaft can be attached to the clutch and pass through an opening on the second part and attached to the mounting bracket on the other side of the opening from the clutch. A first cable can be routed though a gap between the clutch and the mounting bracket (at 730).

The first cable on the first side of the clutch. The shaft that is connected to the clutch can extend from the first side of the clutch. The first cable can be installed along the first side to the shaft. The first cable can be installed along the shaft extending from the clutch to the display housing. In one embodiment, the tab on the mounting bracket creates a space between the shaft and the tab. The space between the tab and the shaft can be used to route the first cable into the display housing without routing the first cable from the side of the mounting bracket attached to the shaft to the opposite side of the mounting bracket. If the cable routed from the side of the mounting bracket attached to the shaft to the opposite side the size of the display housing may increase to accommodate the mounting bracket and the cable.

The second cable can be installed on the second side of the clutch. The second side of the clutch can be opposite the first side of the clutch. The second cable may have limited room to be routed into the display housing because of the components that may be mounted at the bottom of the display housing. If the second cable has limited routing area the second cable may be routed with the first cable.

In one embodiment, a cover can be attached to the clutch or the cover may be attached to the base of the portable computing device. If the cover is attached to the clutch the cover can snap around the clutch to hold the cover in place. The cover may alternatively be attached to the clutch using a fastener, for example a screw, rivet or an adhesive.

What is claimed is:

1. A hinge system comprising:
a clutch 105 attached to a first part of a computing device;
a shaft 110 including a mounting bracket 120 to attach to a second part of the computing device, wherein the shaft extends from a first side 113 of the clutch;
a first cable 430 routed between the first side and the mounting bracket from the first part of the computing device to the second part of the computing device; and
a second cable 435 routed on a second side 114 of the clutch from the first part of the computing device to the second part of the computing device.

2. The hinge system of claim 1, further comprising a cover 225 attached to the clutch.

3. The hinge system of claim 2, wherein the cover 225 protects the first cable and the second cable.

4. The hinge system of claim 1, further comprising a first opening 555 in the second part to allow the shaft and the first cable through.

5. The hinge system of claim 1, further comprising a second opening 550 in the second part to allow the second cable through.

6. The hinge system of claim 1 wherein the first part 545 is a base of the computing device.

7. The hinge system of claim 1 wherein the second part 540 is a display housing of the computing device.

8. The hinge system of claim 1, wherein the first side 113 of the clutch is opposite the second side 114 of the clutch.

9. The hinge system of claim 1, further comprising a tab 122 attached to the mounting bracket, wherein a space is between the tab and the shaft to allow the first cable between the tab and the shaft.

10. A method of installing a first cable in a computing device, comprising:
attaching a clutch 105, including a first side 113, to a first part of the computing device;
attaching a mounting bracket 120 to a second part of the computing device, wherein the clutch and the mounting bracket are connected by a shaft 110; and
installing the first cable 430 though a gap between the first side of the clutch and the mounting bracket.

11. The method of claim 10, further comprising routing the second cable 435 on a second side 114 of the clutch opposite the first side of the clutch.

12. The method of claim 10, further comprising routing the first cable 430 along the shaft.

13. The method of claim 10, further comprising attaching a cover 225 to the clutch.

14. A device to attach a first part of a computing device to a second part of the computing device comprising:
a clutch 105 including a first side 113 and a second side 114 to attach to the first part;
a shaft 110 extending from the clutch on the first side;
a mounting bracket 120 to attach the shaft to the second part, wherein a gap 112 is between the mounting bracket and the clutch to allow a first cable to route along the first side and through the gap.

15. The device of claim 14 wherein a distance between the mounting bracket 120 and the clutch 105 is between 0.5 centimeters and 1.5 centimeters.
